(19) United States
(12) Patent Application Publication
(10) Pub. No.: US 2003/0200162 A1
(43) Pub. Date: Oct. 23, 2003

(54) Secure peer-to-peer money transfer

(75) Inventor: David Carroll Challener, Raleigh, NC (US)

Correspondence Address: IBM CORPORATION, PO BOX 12195, DEPT 9CCA, BLDG 002, RESEARCH TRIANGLE PARK, NC, 27709, US

(73) Assignee: INTERNATIONAL BUSINESS MACHINES CORPORATION, Armonk, NY (US)

(21) Appl. No.: 10/063,397

(22) Filed: Apr. 18, 2002

(51) Int. Cl. G06F 17/60

(52) U.S. Cl. 705/35

(57) ABSTRACT

Direct money transfer between users of a computer aided transaction service such as an auction is accomplished by the use of a common money transfer agent, with which both parties will have established accounts. Security of such transactions is assured by embedding encryption characteristics into data strings exchanged and in which the identities of the parties and details of the transaction are reflected.

### BACKGROUND OF THE INVENTION

Buyers and sellers engaging in transactions on computer based auctions such as those offered over eBay.com encounter some difficulty in carrying a transaction to completion by a money transfer from one user to the other. Some sellers will directly accept credit card purchases, if established as merchants with a money transfer agent such as a bank. Others require physical delivery of a money instrument such as a postal money order. Still others may subscribe to various payment transfer agencies which have arisen in response to online auction activity, such as the service known as PayPal.

While such possibilities have enabled growth of computer based auctions into significant businesses with substantial exchanges of goods, it remains desirable to facilitate and simplify the money transfers necessary to support a buyer/seller relationship. Further, there are concerns about the security of money exchange transactions which are understandable and, in the view of at least some users, are inadequately addressed by the possible arrangements described above.

### SUMMARY OF THE INVENTION

For the reasons given, it is a purpose of this invention to enable money transfers directly between two users of a computer based auction or other buying/selling relationship where value is to be exchanged. In realizing the purposes of this invention, security and speed of such transactions are enhanced, thereby enabling better and smoother flow of commerce in such transactions. Direct money transfer between users is accomplished by the use of a common money transfer agent, with which both parties will have established accounts.

### BRIEF DESCRIPTION OF THE DRAWINGS

Some of the purposes of the invention having been stated, others will appear as the description proceeds, when taken in connection with the accompanying drawings, in which:

FIG. 1 is a flowchart schematically representing the sequence of occurrences in carrying out a transaction in accordance with this invention;

FIG. 2 is a schematic representation of apparatus through which two users may implement the sequences of FIG. 1; and

FIG. 3 is a representation of a computer readable medium which carries computer readable code which, when executing on a user's system, enables the sequences of FIG. 1 in the apparatus of FIG. 2.

### DETAILED DESCRIPTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

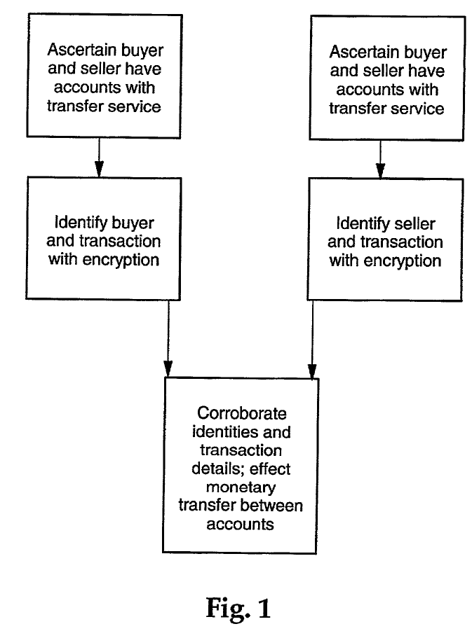

In accordance with this invention, a money exchange between two users of a service such as a computer based auction begins with a step of ascertaining that a buyer and a seller engaging in a transaction through a computer network maintain accounts at a common monetary transfer service. When an imminent transaction is reached and the terms and conditions have been established by whatever offer and acceptance may be exchanged, one party (nominally the buyer) is identified to and transaction details forwarded to a monetary transfer service by a data sequence which includes a character string derived from a buyer account identification by the addition of encrypting characteristics. The money transfer service may be a bank or other financial institution or, where permitted by law, some other agency which serves the purpose of maintaining user accounts in which debits and credits may be recorded and to and from which currency based transaction may be concluded between the service and its users. The addition of encrypting characteristics may take a range of possibilities, discussed more fully hereinafter, and is a significant characteristics of the methods and apparatus here described. The other party (nominally the seller) is likewise identified to and transaction details forwarded to the monetary transfer service by a data sequence which includes a character string derived from a seller account identification by the addition of encrypting characteristics. There then follows the effecting at the monetary transfer service of a debit transaction to the buyer's account and a credit transaction to the seller's account. These sequences are represented schematically in FIG. 1 where a flowchart of the steps is shown.

Security for the money transfers following the process described is determined in some large measure by the monetary transfer service, and by adherence of the users to the procedures implemented. By way of examples, each user may be provided with an access card in the form of a smart card or other device carrying a security chip or other device encoded with identifying information. The identifying information exchanged between a user and the service, however based or derived, may be encrypted /decrypted during transfer using known private key/public key technology. This will be the case even where the user identification is derived only by manual entrance of a data string such as an account number, user name, password or the like, similarly to current usage of computer based auction services and the like. The smart card or other device may be replaced by a biometric measure, a number of types of which have been proposed and brought into use. Any of the security regulation steps can be taken in order to assure that the monetary transfer service is confident that the two users between whose accounts the transfer of value is to occur are in fact who they represent themselves to be and are in fact engaged in a transaction which has identical terms and conditions from each of them.

Where the monetary transfer service is based upon any of the known major credit card services, then the users will have the additional assurance of current laws permitting protection of the transaction from misrepresentation discovered later, incorrect charges, etc. In this instance, the two users would simply maintain accounts with the common credit card service, which could be any of the widely known brands. Both users and service providers can promote and advertise the availability of this near instantaneous completion of money transfers.

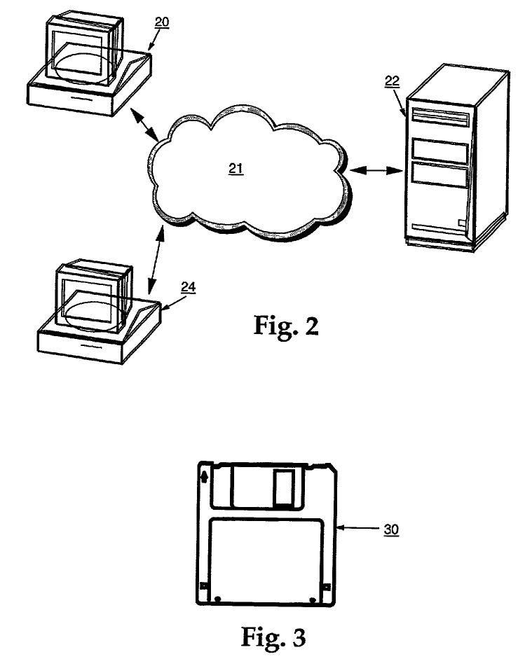

As will be understood, users of the procedures here described will use apparatus which will have a buyer's station (20 in FIG. 2) from which a buyer transmits through a computer network (21 in FIG. 2) to a monetary transfer service 22a data string identifying an account maintained by the buyer with the monetary transfer service and the details of a transaction with a seller and a first program module executing on the buyer's station which embeds in a transmitted data string a character string derived from a buyer account identification by the addition of encrypting characteristics. A seller will have a seller's station 24 from which a seller transmits through the computer network 21 to the monetary transfer service 22a data string identifying an account maintained by the seller with the monetary transfer service and the details of a transaction with the buyer, with a second program module executing on the seller's station which embeds in a transmitted data string a character string derived from a seller account identification by the addition of encrypting characteristics. The monetary service 22 will have a monetary transfer service station 22a at which transmissions from buyers and sellers are received, and at which a third program module executing on the monetary transfer service station identifies from the transmitted data strings the buyer, seller and transaction details and which effects a debit transaction to the buyer's account and a credit transaction to the seller's account.

In practice, a user may be a buyer for some transactions and a seller for others.

The present invention also contemplates a program product as illustrated in FIG. 3 where a computer readable medium such as a diskette 30 carries a program module stored accessibly to a computer system which, when executing on a computer system, ascertains that a user of the computer system is one of buyer and a seller engaging in a transaction through a computer network and maintaining an account at a monetary transfer service common to the other of the buyer and seller, identifies the user and transaction details to the monetary transfer service by a data sequence which includes a character string derived from a user account identification by the addition of encrypting characteristics and, in the event that the other of the buyer and seller transmits to the monetary transfer service data identifying the other and transaction details by a data sequence which includes a character string derived from the other's account identification by the addition of encrypting characteristics, effecting at the monetary transfer service a debit transaction to the buyer's account and a credit transaction to the seller's account.

In the drawings and specifications there has been set forth a preferred embodiment of the invention and, although specific terms are used, the description thus given uses terminology in a generic and descriptive sense only and not for purposes of limitation.

1. A method comprising the steps of:
ascertaining that a buyer and a seller engaging in a transaction through a computer network maintain accounts at a common monetary transfer service;
identifying the buyer and transaction details to the monetary transfer service by a data sequence which includes a character string derived from a buyer account identification by the addition of encrypting characteristics;
identifying the seller and transaction details to the monetary transfer service by a data sequence which includes a character string derived from a seller account identification by the addition of encrypting characteristics; and
effecting at the monetary transfer service a debit transaction to the buyer's account and a credit transaction to the seller's account.

2. Apparatus comprising:
a buyer's station from which a buyer transmits through a computer network to a monetary transfer service a data string identifying an account maintained by the buyer with the monetary transfer service and the details of a transaction with a seller;
a first program module executing on the buyer's station which embeds in a transmitted data string a character string derived from a buyer account identification by the addition of encrypting characteristics;
a seller's station from which a seller transmits through a computer network to the monetary transfer service a data string identifying an account maintained by the seller with the monetary transfer service and the details of a transaction with the buyer;
a second program module executing on the seller's station which embeds in a transmitted data string a character string derived from a seller account identification by the addition of encrypting characteristics;
a monetary transfer service station at which transmissions from buyers and sellers are received; and
a third program module executing on the monetary transfer service station which identifies from the transmitted data strings the buyer, seller and transaction details and which effects a debit transaction to the buyer's account and a credit transaction to the seller's account.

3. Apparatus comprising:
a computer readable medium; and
a program module stored on said medium accessibly to a computer system;
said program module, when executing on a computer system,
ascertaining that a user of the computer system is one of buyer and a seller engaging in a transaction through a computer network and maintaining an account at a monetary transfer service common to the other of the buyer and seller;
identifying the user and transaction details to the monetary transfer service by a data sequence which includes a character string derived from a user account identification by the addition of encrypting characteristics; and
in the event that the other of the buyer and seller transmits to the monetary transfer service data identifying the other and transaction details by a data sequence which includes a character string derived from the other's account identification by the addition of encrypting characteristics, effecting at the monetary transfer service a debit transaction to the buyer's account and a credit transaction to the seller's account.
